(19) United States
(12) Patent Application Publication
(10) Pub. No.: US 2006/0230341 A1
(43) Pub. Date: Oct. 12, 2006

(54) Image editing apparatus and image editing method

(75) Inventor: Naofumi Yamamoto, Kawasaki-shi (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 11/080,927

(22) Filed: Mar. 16, 2005

(51) Int. Cl. G06F 17/00; G09G 5/00

(52) U.S. Cl. 715/517; 715/530; 345/629

(57) ABSTRACT

In an image editing apparatus, an image input section inputs an original image. A processor section compresses the input image and stores the compressed input image as an image file in a memory section. The processor section decompresses the image file that is stored in the memory section, and executes a layout analysis process and extracts layout information. Based on the layout information obtained by the layout analysis process and a prescribed rule, the processor section executes rearrangement of layout. Image information, which includes the rearranged information and layout information before and after the rearrangement, is stored in the memory section as a file.

### BACKGROUND OF THE INVENTION

1. Field of the Invention

The present invention relates to an image editing apparatus and an image editing method, which execute editing of a layout of an image.

2. Description of the Related Art

With rapid development and increasing popularity of infrastructures, such as the Internet, storages and computers, for transmission, storage and processing of digital images, it has become convenient more and more to handle images as electronic documents, although they have conventionally been treated as paper.

The use of electronic documents has the following advantages. Quick and easy transmission of documents is possible. A space for storing and keeping documents is saved. Electronic documents are free from degradation with time of paper. Quick and easy retrieval of documents is possible, and all or part of an electronic document can be used to create a new document.

Most of such electronic documents are generated by various document-creating software, such as word-processing software, and general-purpose computers such as personal computers. However, it is additionally necessary to convert existing paper documents to electronic documents.

Methods for converting a paper document to an electronic document include a method of reading a paper document by an image input apparatus such as a scanner. Widely used file formats for read images are bitmap formats such as BMP and TIFF, and compression formats such as JPEG.

The bitmap format, however, does not include layout information or character code information, which represents differences in figures, characters and photos. In this case, it is difficult to execute an editing process of retrieving a read document, reusing a part of the document, rearranging contents of the document and deleting a part of the document.

In general, in the case of bitmap formats, high-ratio compression with high image quality is difficult. As a result, such a problem arises that the file size becomes very large and a great deal of time and cost is consumed in such uses as storage and transmission.

In addition, a complex procedure has to be executed when a document image is reused, that is, when a part of a document image is clipped and used in creating another document.

For example, when a specific region in a document image is clipped, it is necessary to designate the coordinate values of the specific region or to designate a circumscribed rectangular frame by means of a pointing device or the like. In order to designate one region, it is necessary to input a plurality of (normally two or more pairs of) coordinate values through a keyboard, or to designate at least two points, e.g. an upper left point and a lower right point of a circumscribed rectangle of the specific region. This leads to time-consuming operations.

Besides, in a case where a figure/table, a photo and a character are included in a multi-page document image, it is also time-consuming to find and clip such a figure/table, a photo or a character.

In an ordinary document, a figure/table or a photo is inserted between passages. If a document contains several-ten pages, it is time-consuming to find a photo or a figure/table. Besides, a passage may be split apart by a photo or a figure/table. In this case, when the passage is to be encoded by an OCR, the passage is split away and the split parts have to be connected by a time-consuming manual work.

### BRIEF SUMMARY OF THE INVENTION

The object of an aspect of the present invention is to provide an image editing apparatus and an image editing method, which can easily lay out structural elements, such as a passage, a photo or a figure/table, of an image obtained by scanning a document image, thus facilitating reuse of the image.

According to an aspect of the present invention, there is provided an image editing apparatus comprising: image input means for inputting image information; layout analysis means for extracting layout information by analyzing a layout structure of the image information that is input by the image input means; rearrangement means for executing rearrangement of layout on the basis of the layout information, which is extracted by the layout analysis means, and predetermined rule information; and output means for outputting image information, which is rearranged by the rearrangement means, as a file or a stream of a predetermined format.

According to another aspect of the present invention, there is provided an image editing method for editing an image, comprising: analyzing a layout structure of input image information and extracting layout information; executing rearrangement of layout on the basis of the extracted layout information, and predetermined rule information; and outputting the rearranged image information as a file or a stream of a predetermined format.

Additional objects and advantages of an aspect of the invention will be set forth in the description which follows, and in part will be obvious from the description, or may be learned by practice of the invention. The objects and advantages of an aspect of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate preferred embodiments of the invention, and together with the general description given above and the detailed description of the embodiments given below, serve to explain the principles of an aspect of the invention.

FIG. 1 is a block diagram that schematically shows the structure of an image editing apparatus according to a first embodiment of the invention;

FIG. 2 is a flow chart illustrating an image editing process in the first embodiment;

FIG. 3 shows an example of an original image;

FIG. 4 shows an example of a layout analysis result;

FIG. 5 shows an example of descriptions of layout;

FIG. 6 shows an example of coordinates of character regions;

FIG. 7 shows a specific example of a rule;

FIG. 8 shows an example of a result of a rearranged image;

FIG. 9 is a block diagram that schematically shows the structure of an image editing apparatus according to a second embodiment of the invention;

FIG. 10 is a flow chart illustrating an image editing process in the second embodiment;

FIG. 11 shows a processing result by layout analysis; and

FIG. 12 shows an example of a correction result.

### DETAILED DESCRIPTION OF THE INVENTION

Embodiments of the present invention will now be described with reference to the accompanying drawings.

An image editing apparatus according to the invention analyzes a layout structure of a document image that is read by, e.g. a scanner, automatically rearranges the layout, and outputs, as a file, the rearranged layout including pre-editing information.

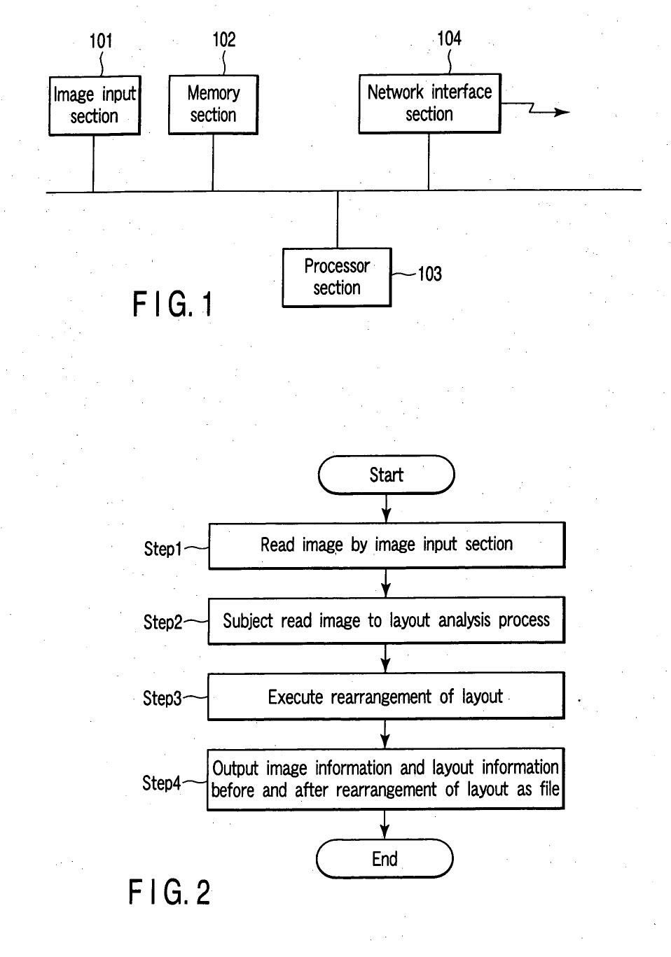

FIG. 1 schematically shows the structure of an image editing apparatus according to a first embodiment of the present invention. The image editing apparatus comprises an image input section 101, a memory section 102, a processor section 103 and a network interface section 104.

The image input section 101 reads a document image and outputs electronic image information.

The memory section 102 stores an image file that is read by the image input section 101, and an edited image file, which will be described later in detail.

The processor section 103 executes conversion of an image file, a series of operations, and a process control.

The network interface section 104 executes transmission/reception of, e.g. an image file with the outside via a network (not shown).

Referring to a flow chart of FIG. 2, a description is given of an image editing process by the image editing apparatus of the first embodiment with the above-described structure.

To start with, in step 1, the image input section 101 inputs an original image. The image input from the image input section 101 is subjected to a compression process of, e.g. JPEG in the processor section 103, and the compressed image is stored in the memory section 102.

In the present embodiment, a standard JPEG compression process is applied in consideration of the capacity of the memory section 102 and the ease in transmission/reception of a file with the outside. The compression scheme, however, is not limited to JPEG, and other compression schemes are applicable. Alternatively, the input image may be stored without compression.

In step 2, the processor section 103 decompresses the image file that is stored in the memory section 102, and executes a layout analysis process and extracts layout information.

The layout analysis is described below.

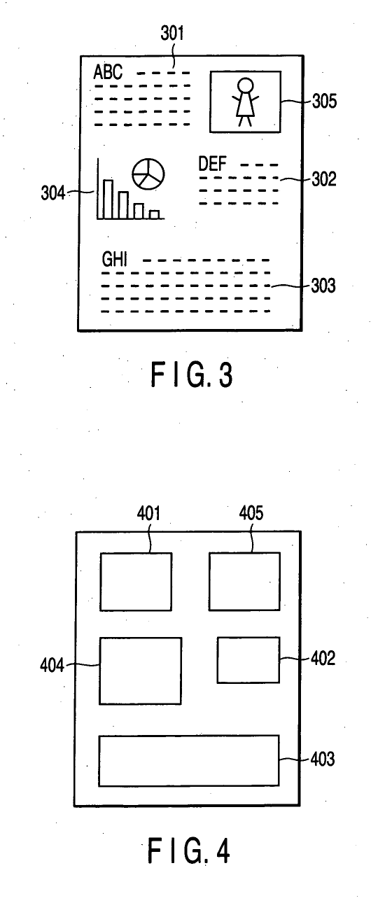

FIG. 3 shows an original image, which comprises character regions 301, 302 and 303, a figure/table (graph) region 304, and a photo region 305.

In the layout analysis process, separation of regions and determination of the kind of each region are executed with respect to the image.

A layout analysis method is disclosed, for instance, in Japanese Patent No. P3504054.

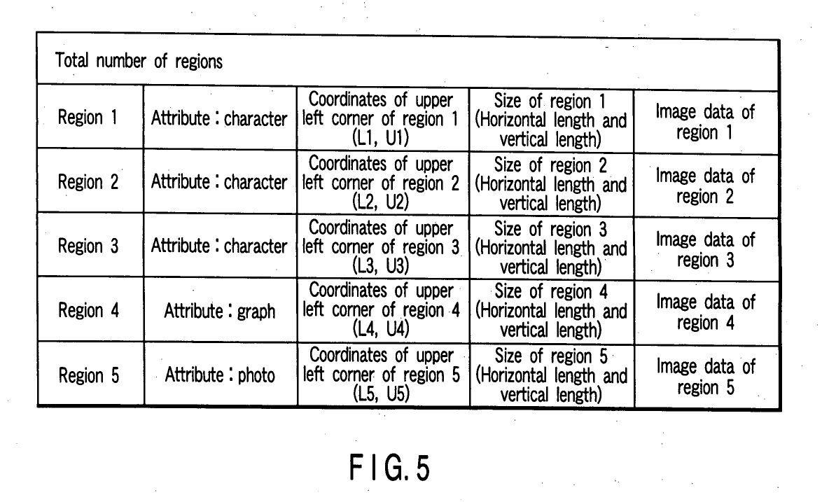

FIG. 4 shows an example of a layout analysis result. The respective regions of the characters, graph and photo are expressed as rectangular regions 401, 402, 403, 404 and 405. FIG. 4 schematically shows the analysis result. In fact, as shown in FIG. 5, the respective regions are described as sets of coordinates of rectangular regions, information indicative of the size and the kind of each region, and information indicative of the image of each region. Further, the extracted regions are numbered in order.

In this example, there are three character regions. Thus, the three regions are numbered in order on the basis of coordinate positions. The uppermost region is given a highest position in the order, and a lower region is given a lower position in the order. In this case, the order of the character regions 301, 302 and 303 is given. The order is not limited to this. On the basis of descriptions of the rule, the order may be set from the lowermost one, or from the leftmost one. In the case of a multiple-row original, the order may be set in accordance with multiple rows.

The rule of ordering will now be described.

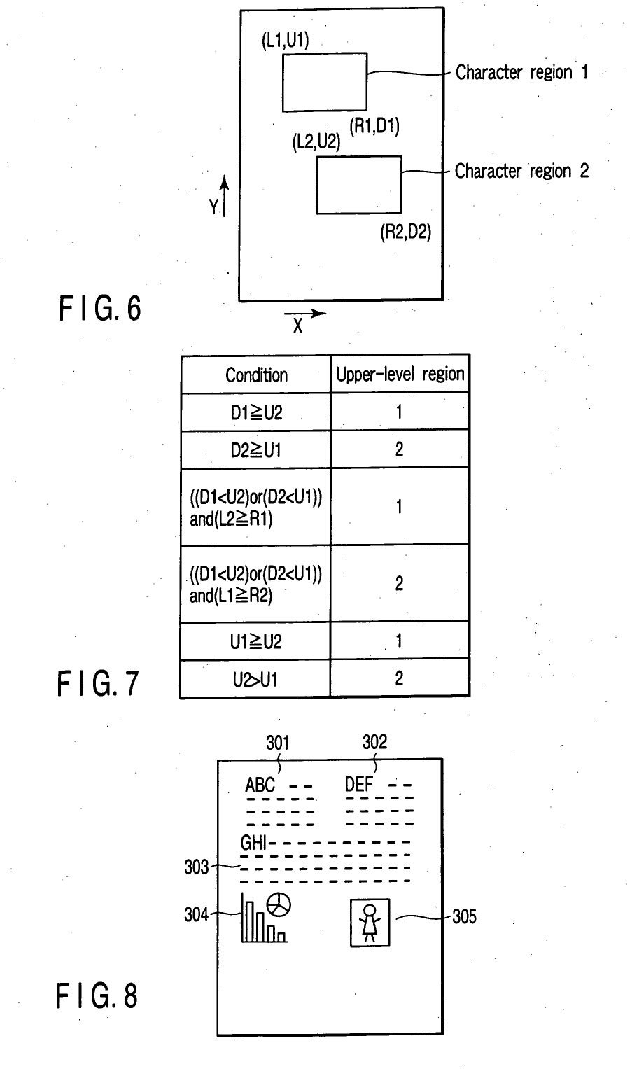

FIG. 6 shows an example of coordinates of character regions.

As is shown in FIG. 6, the coordinates of the upper left corner of the circumscribed rectangle of the character region 1 are set at (L1, U1), and the coordinates of the lower right corner thereof are set at (R1, D1). Similarly, the coordinates of the upper left corner and lower right corner of the circumscribed rectangle of the character region 2 are set at (L2, U2) and (R2, D2). The coordinate values in the Y axis (vertical) become greater in the downward direction, and the coordinate values in the X axis (horizontal) become greater in the rightward direction.

FIG. 7 shows a concrete example of the rule.

Evaluation based on the rule shown in FIG. 7 is successively applied to the regions from one on the uppermost row. The region that first meets the condition is written in the right column as the upper-level region. This ordering of regions is successively executed with respect to each of all character regions. Similarly, the ordering of the graph region and photo region is executed. Thus, the comprehensive ordering is performed in an order of the character regions, graph region and photo region.

The order in the layout shown in FIG. 3 and FIG. 4 is as follows: the character region 301, character region 302, character region 303, graph region 304 and photo region 305.

In step 3, the processor section 103 executes rearrangement of the layout on the basis of the layout information, which has been obtained by the layout analysis process, and the prescribed rule.

For example, the character regions are first arranged from the uppermost one, following which the graph region and photo region are arranged. An example of the rule of rearrangement is as follows. The first region is positioned at an upper left corner of the page. If the sum of the horizontal size (R2-L2) of the second region and the horizontal size of the first region is less than the effective horizontal size of the page, the second region is positioned on the right side of the first region. If not, the second region is positioned under the first region at the left end. Similar rearrangement is repeated. In fact, images need not be moved, but only coordinate values of positions for rearrangement may be stored.

FIG. 8 shows an example of the result of rearrangement of the images shown in FIG. 3. In FIG. 8, the character region 301 is positioned on the left side of the uppermost row, and the character region 302 is positioned on the right side of the uppermost row. The character region 303 is positioned in the second row, the graph region 304 is arranged on the left side of the third row, and the photo region 305 is arranged on the right side of the third row.

In step 4, the processor section 103 stores image information, which includes information on the rearrangement and layout information before and after the rearrangement, in the memory section 102 in the form of a file. The method of storing image data is as follows. For example, a bitmap image is reconstructed from the rearrangement information, and the image and the layout information before and after the rearrangement may be stored. Alternatively, image information of each region and layout information before and after rearrangement may be stored.

Thereby, the layout can be changed by the simple operation so as to meet the user's intention.

As has been described above, according to the first embodiment, the layout of an image that is read by the image input section can automatically be rearranged. Thereby, only character regions can be gathered, and character regions are arranged continuous. Thus, extraction of character regions and a coding operation using OCR become easier.

In addition, since the figure/table (graph) region and photo region are gathered at the last part of the passages, it is easy to find them for reuse.

Next, a second embodiment is described.

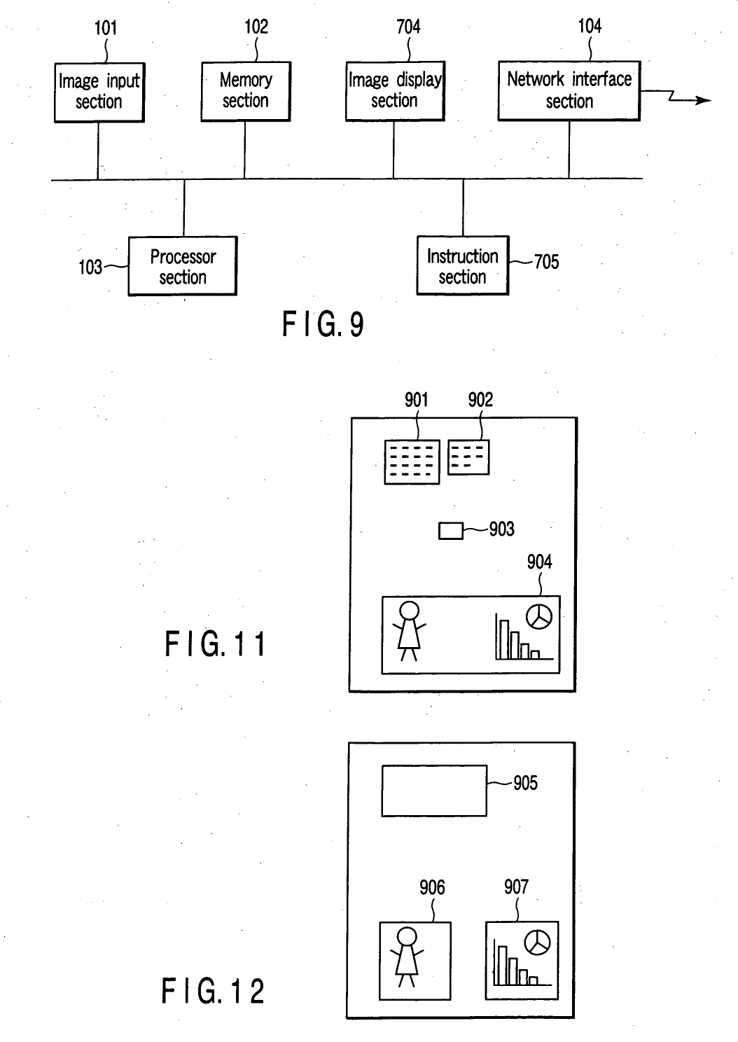

FIG. 9 schematically shows the structure of an image editing apparatus according to the second embodiment of the invention. The image editing apparatus comprises an image input section 101, a memory section 102, a processor section 103, a network interface section 104, an image display section 704, and an instruction section 705. The parts common to those in the first embodiment are denoted by like reference numerals, and a description thereof is omitted.

The image display section 704 displays an image or an editing result, which is stored in the memory section 102.

The instruction section 705 functions to input the kind of editing for an image, as instructed by the user, and to designate regions for editing in cooperation with the image display section 704.

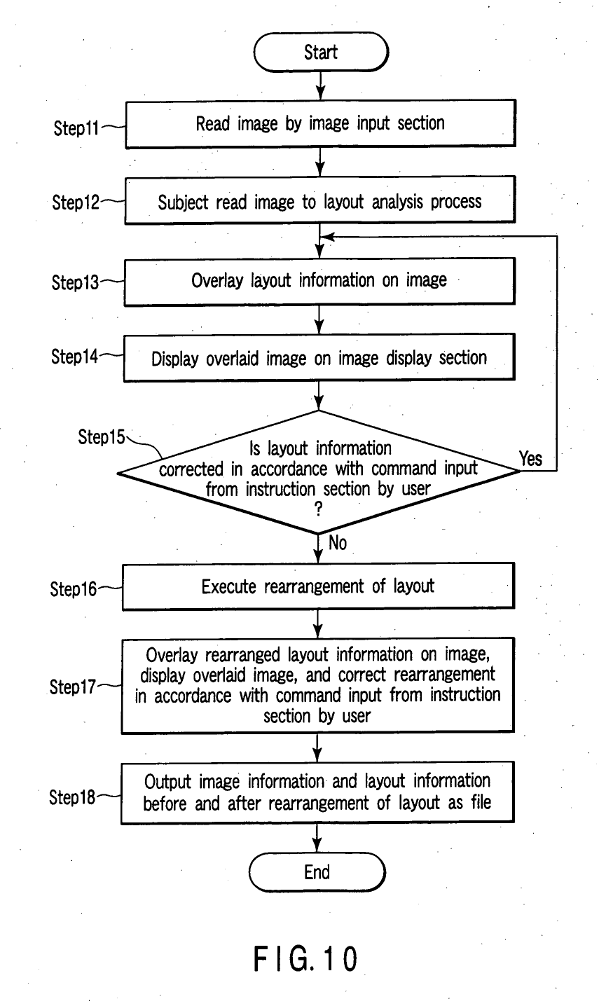

Referring now to a flow chart of FIG. 10, a description is given of an image editing process by the image editing apparatus of the second embodiment with the above-described structure.

To start with, in step 11, the image input section 101 inputs an original image. The image input from the image input section 101 is subjected to a compression process of, e.g. JPEG in the processor section 103, and the compressed image is stored in the memory section 102.

In step 12, the processor section 103 decompresses the image file that is stored in the memory section 102, and executes a layout analysis process and extracts layout information.

In step 13, the processor section 103 overlays the layout information on the original image. In this embodiment, on the basis of information of a rectangular region obtained by the layout analysis, a line that represents a rectangular outer frame is overlaid on the original image, and thus an overlay image is formed. The overlay image is used in the next step when the layout information is displayed and the user confirms the result of the layout analysis. It is thus preferable that the overlay line be clearly recognizable on the original image.

The method of overlaying is as follows. For example, a line of a specific color may be written over the original image, and an XOR operation may be executed with the pixel values of associated pixels of the original image. Alternatively, average density information of an original image is found. If the average density is low, a line of a high-density color is overlaid. If the average density is high, a line of a low-density color is overlaid.

In step 14, the processor section 103 displays the overlaid image on the image display section 704.

In step 15, the processor section 103 alters the layout information in accordance with a command or region information, which is input by the user through the instruction section 704. For example, when the user views the overlaid image information in step 14 and corrects the layout information, the user instructs correction of the layout information in step 15 through the instruction section 705. Examples of the correction of layout information include an alteration of the position or size of the region, a change of the attribute of the region, deletion of the region, addition of a new region, and merging of two regions.

In the present embodiment, the command is input as follows.

To start with, a frame line of the region is designated by a pointing device (e.g. a mouse of a personal computer) of the instruction section 705, which operates in association with the cursor display on the image display section 704, and the region is designated by, e.g. a clicking operation of the mouse. The image display section 704 displays a pop-down menu for selection of the correction process. Similarly, the correction process is selected by the pointing device.

If the correction of the layout information is instructed in step 15, the processor section 103 repeats steps 13, 14 and 15 in accordance with the corrected layout information. When the user has issued a command for finishing the editing in step 15, this process loop is ended and the control goes to step 16.

The purpose of steps 13 to 15 is explained in brief.

The layout analysis in step 12 is an automatic process. Consequently, in some cases, there is an error in the layout information that is the result of the process, or a process result does not agree with the user's expectation. Such an error or disagreement is corrected in steps 13 to 15.

FIGS. 11 and 12 show an example of layout information and an example of the correction.

FIG. 11 shows a process result of the layout analysis, and FIG. 12 shows an example of the correction result. In FIG. 11, one character region is recognized as two regions 901 and 902. By merging the regions 901 and 902, these regions are integrated into a single region 905, as shown in FIG. 12. In addition, in FIG. 11, a stain on a central area is recognized as a region 903. This region 903 can manually be deleted. Besides, in FIG. 11, a graph region and a photo region are recognized as one region 904. By executing separation correction, the region 904 can be divided into a photo region 906 and a graph region 907.

In step 16, the processor section 103 executes rearrangement on the basis of the prescribed rule and the layout information that is the correction result of the process up to step 15.

In step 17, the processor section 103 displays once again an overlay image on the image display section 704 on the basis of the rearranged layout information, and corrects the rearrangement in accordance with the user's command, as in steps 13 to 15.

In step 18, the processor section 103 stores image information, which includes information on the rearrangement and layout information before and after the rearrangement, in the memory section 102 in the form of a file.

As has been described above, according to the second embodiment, the rearrangement of layout is automatically executed and the editing and reuse of an electronic document image are made easier.

The arrangement of regions on the original image can manually be corrected in an interactive manner. Thus, even if the result of rearrangement does not agree with the user's expectation, the rearrangement can be corrected by a simple operation.

Even in the case where there is an error in the result of layout analysis or disagreement with the user's expectation, such an error or disagreement can be corrected.

A result of the layout analysis is displayed in an overlay fashion, and the layout can be corrected. Thus, there is no need to input coordinates or a rectangular area, and the correction can be made by a simple operation.

Furthermore, since the image information before and after rearrangement is stored in a file, a layout image similar to the original image can easily be restored.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An image editing apparatus comprising:
image input means for inputting image information;
layout analysis means for extracting layout information by analyzing a layout structure of the image information that is input by the image input means;
rearrangement means for executing rearrangement of layout on the basis of the layout information, which is extracted by the layout analysis means, and predetermined rule information; and
output means for outputting image information, which is rearranged by the rearrangement means, as a file or a stream of a predetermined format.

2. The image editing apparatus according to claim 1, wherein the output means outputs the rearranged image information and image information before and after the rearrangement as a file or a stream of a predetermined format.

3. An image editing apparatus comprising:
image input means for inputting image information;
layout analysis means for extracting layout information by analyzing a layout structure of the image information that is input by the image input means;
overlay means for overlaying the layout information, which is extracted by the layout analysis means, on the image information;
display means for displaying overlaid image information that is formed by the overlay means;
instruction means for instructing an editing operation and an editing region in association with the overlaid image information that is displayed on the display means;
alteration means for altering the layout information in accordance with an editing instruction from the instruction means;
rearrangement means for executing rearrangement of layout on the basis of the layout information, which is altered by the alteration means, and predetermined rule information; and
output means for outputting image information, which includes information rearranged by the rearrangement means and layout information before and after the rearrangement, as a file or a stream of a predetermined format.

4. The image editing apparatus according to claim 3, further comprising first control means for controlling, until an instruction for finishing editing is issued from the instruction means, the alteration means that operates according to the editing instruction from the instruction means, the overlay means using the layout information altered by the alteration means, and the display means.

5. The image editing apparatus according to claim 3, further comprising second control means for executing, until an instruction for finishing editing is issued from the instruction means, a control to overlay the information, which is rearranged by the rearrangement means, on the image information, to display the overlaid image information on the display means, and to correct the rearrangement in accordance with an instruction from the instruction means.

6. An image editing method for editing an image, comprising:
analyzing a layout structure of input image information and extracting layout information;
executing rearrangement of layout on the basis of the extracted layout information, and predetermined rule information; and
outputting the rearranged image information as a file or a stream of a predetermined format.

7. The image editing method according to claim 6, wherein the rearranged image information and image information before and after the rearrangement are output as a file or a stream of a predetermined format.

8. An image editing method for editing an image, comprising:
analyzing a layout structure of input image information and extracting layout information;
overlaying the extracted layout information on the image information;
displaying the overlaid image information;
instructing an editing operation and an editing region in association with the overlaid image information that is displayed;
altering the layout information in accordance with an editing instruction;
executing rearrangement of layout on the basis of the altered layout information and predetermined rule information; and
outputting image information, which includes the rearranged information and layout information before and after the rearrangement, as a file or a stream of a predetermined format.

9. The image editing method according to claim 8, further comprising executing, until an instruction for finishing editing is issued, a control to alter the layout information according to the editing instruction, to overlay the altered layout information on the image information, and to display the overlaid image information.

10. The image editing method according to claim 8, further comprising executing, until an instruction for finishing editing is issued, a control to correct the rearrangement in accordance with an editing instruction, to overlay the information of the corrected rearrangement on the image information, and to display the overlaid image information.
